(19) United States
(12) Patent Application Publication
(10) Pub. No.: US 2015/0119075 A1
(43) Pub. Date: Apr. 30, 2015

(54) Integrated Land Mobile Radios (LMRs) with Cellular Location Nodes

(71) Applicant: TeleCommunication Systems, Inc., Annapolis, MD (US)

(72) Inventors: Paul Thompson, Bothell, WA (US); Grant Gifford, Anacortes, WA (US); Gordon John Hines, Kirkland, WA (US)

(21) Appl. No.: 14/528,368

(22) Filed: Oct. 30, 2014

Related U.S. Application Data
(60) Provisional application No. 61/898,085, filed on Oct. 31, 2013.

(51) Int. Cl. H04W 64/00; H04W 4/02

(52) U.S. Cl. CPC H04W 64/00; H04W 4/02
USPC 455/456.1

(57) ABSTRACT

A system and method to locate a person who happens to be carrying multiple devices when one network (LMR or cell) is incapable of providing a current location of a mobile person for whatever reason (network outage, weather-related outage, emergency, etc.), while the other network (cell or LMR) is able to provide current location information.

The application claims priority from U.S. Prov. No. 61/898,085, entitled “Integrated Land Mobile Radios (LMRs) With Cellular Location Nodes” filed Oct. 31, 2013, the entirety of which is explicitly incorporated herein by reference.

### BACKGROUND OF THE INVENTION

1. Field of the Invention

This invention relates generally to wireless telecommunication, and more particularly to location services and public safety.

2. Background of Related Art

Existing land mobile radios (LMRs) can support A-GPS and pushing A-GPS to proprietary systems developed by LMR vendors. The capability is available in commercial radios as well as the Amateur Radio Service (ARS). For instance, the Amateur Radio Service provides Automatic Packet Radio Service (e.g., aprs.org) for tracking of ham radios.

However, conventional LMR location services are proprietary and not accessible to other location technologies or devices. Moreover, current LMR systems are also deficient in areas where the LMR device is not visible to GPS satellites.

### SUMMARY OF THE INVENTION

In accordance with the principles of the present invention, a method of providing location of an LMR device in a cellular network, comprises storing, in a physical land mobile radio (LMR) wireless network location service, a current location of a given LMR device. A correlation of location is determined between the given LMR device and a given cellular device. The current location of the given LMR device into a physical GMLC server is PULLed. The current location of the given LMR device is stored, and an identity of the given LMR device, and an identity of the given cellular device, are stored into an LMR to cell identity mapping database. The current location of the given LMR device is accessible in a cellular wireless network to requests for location of the given cellular device.

A method of storing an LMR-determined location in a cellular location cache, comprises PUSHing, from a land mobile radio (LMR) location service server PUSHes a current location of a given LMR device into a physical GMLC server via an interface between the LMR service server and the GMLC server. The current location of the given LMR device is PUSHed from the physical GMLC server into a GMLC location cache.

A method of storing an LMR-determined location in a cellular location cache, comprises PUSHing, from a land mobile radio (LMR) location service server, a current location of a given LMR device into a physical GMLC server via an interface between the LMR service server and the GMLC server. The current location of the given LMR device is PUSHed from the physical GMLC server into a GMLC location cache.

A method of storing an LMR-determined location in a cellular location cache, comprises PUSHing, from a land mobile radio (LMR) location service server, a current location of a given LMR device into a physical SLP server via an interface between the LMR service server and the SLP server. The current location of the given LMR device is PUSHed from the physical SLP server into an SLP location cache.

### BRIEF DESCRIPTION OF THE DRAWINGS

Features and advantages of the present invention will become apparent to those skilled in the art from the following description with reference to the drawings, in which:

FIG. 1 shows the relevant physical modules within an integrated land mobile radio (LMR), being located by a LMR location service over a control plane, and sharing the LMR location with a GMLC for storage in a GMLC cache, in accordance with the principles of the present invention.

FIG. 2 shows the relevant physical modules within an integrated land mobile radio (LMR), and the relevant physical modules within a cellular radio device such as a wireless phone, including both an LMR location service, and a LMR-to-cell Identity Map Database, communicating using a control plane, in accordance with the principles of the present invention.

FIG. 3 shows an integrated land mobile radio (LMR) in a cellular location service using a user plane, in accordance with the principles of the present invention.

### DETAILED DESCRIPTION OF ILLUSTRATIVE EMBODIMENTS

The present invention integrates cellular and Land Mobile Radio (LMR) location services into a single device. The invention discloses adaption of otherwise well-known cellular location methods uniquely integrated into the land mobile radio (LMR) environment, with the result being that LMR calculated positions become available from a standard location cache database (e.g., a GMLC cache database or a SLP cache database).

The present invention enables reliable positioning to be reported from LMR radios into a gateway mobile location center (GMLC), providing LMR-determined location information, which is particularly useful, e.g., in the event that the cellular network fails completely. During many recent weather-damaging events (e.g., during Hurricane Katrina, Hurricane Sandy, etc.), the cellular network failed. Thus, the location of wireless devices could not be obtained. The inventors have appreciated that this is particularly dangerous, e.g., with respect to 9-1-1 emergency calls, first responders in a building on fire, etc. The present invention enables first responder wireless devices, and other wireless devices of users who also have an LMR radio (police, fire fighters, even private companies with tracked fleets, etc.) to be located with at least an LMR-determined location even when the cellular network fails.

The present invention, among other things, adapts a well-defined LTE positioning protocol (LPP) for a new use between Land Mobile Radios (LMR) devices and cellular/mobile devices, and vice versa.

The present invention also enables cellular location techniques in a Land Mobile Radio context.

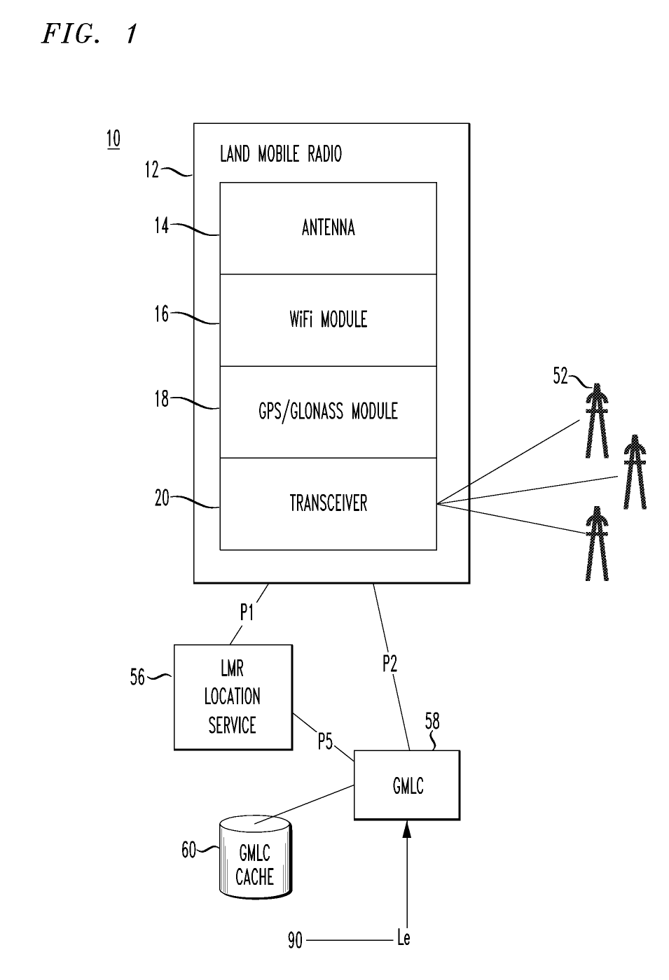

FIG. 1 shows the relevant physical modules within an integrated land mobile radio (LMR), being located by a LMR location service over a control plane, and sharing the LMR location with a GMLC for storage in a GMLC cache, in accordance with the principles of the present invention.

In particular, as shown in FIG. 1, a land mobile radio (LMR) 12 includes an antenna 14, a WiFi module 16, a GPS and/or GLONASS satellite location service chipset 18, and a transceiver 20 in communication with the antenna 14, as is known.

The LMR 12 is located by a LMR location service 56, and the LMR location determined by the LMR location service 56 is either pushed to, or pulled by, a GMLC 58. The GMLC 58 associates the LMR 12 with a wireless device also physically carried by the user of the LMR 12, and stores both that association with an identification of both the LMR 12 and the associated cell device, and its location determined by the LMR location service 56, in an appropriate GMLC cache 60.

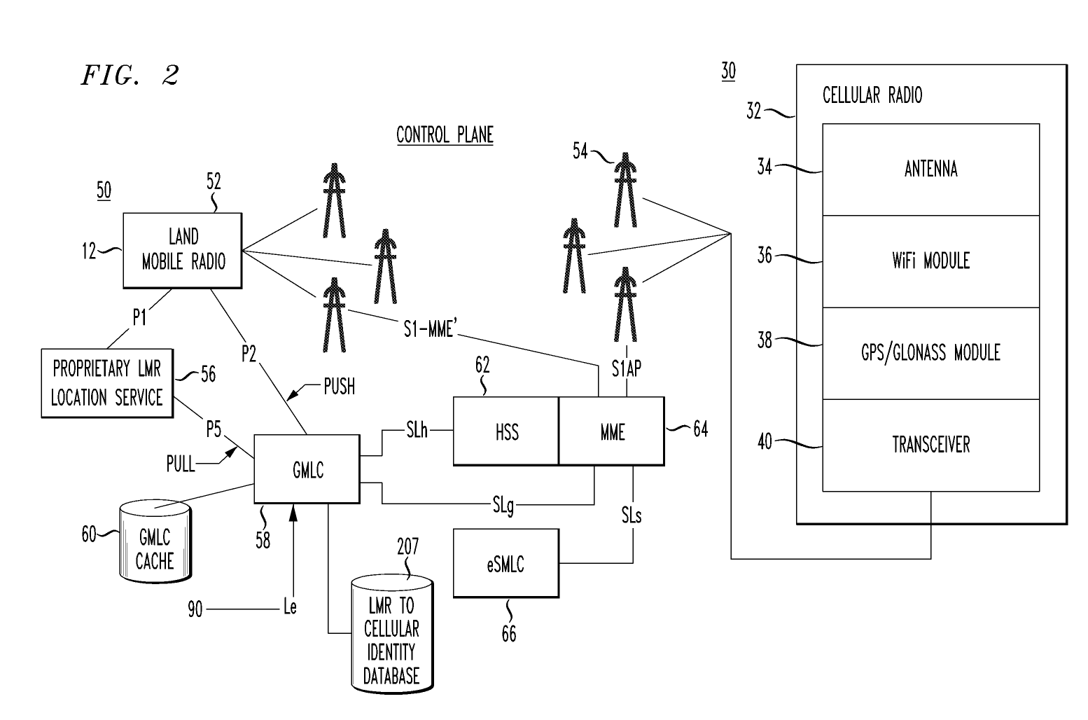

FIG. 2 shows the relevant physical modules within an integrated land mobile radio (LMR), and the relevant physical modules within a cellular radio device such as a wireless phone 32, including both an LMR location service 56, and a LMR-to-cell Identity Map Database, communicating using a control plane, in accordance with the principles of the present invention.

In particular, as shown in FIG. 2, a control plane location services embodiment includes a cellular radio 12 and an LMR 12 both being physically carried by a same user, and thus correlated in location.

The cellular radio 12 includes in pertinent part an antenna 34, a WiFi module 36, a location satellite (e.g. GPS or GLONASS) module 38, and a transceiver 40.

The GMLC components relevant to the control plane location services embodiment include an LMR Antenna/Repeater system 52, a Cellular LTE RAN 54, an LMR Location Service 56, a Gateway Mobile Location Center (GMLC) 58, a GMLC Cache 60, a Home Subscriber Service (HSS) 62, a Mobility Management Entity (MME) 64, an Evolved Serving Mobile Location Center (eSMLC) 66, and an Le Interface 90 that applications use to submit location requests.

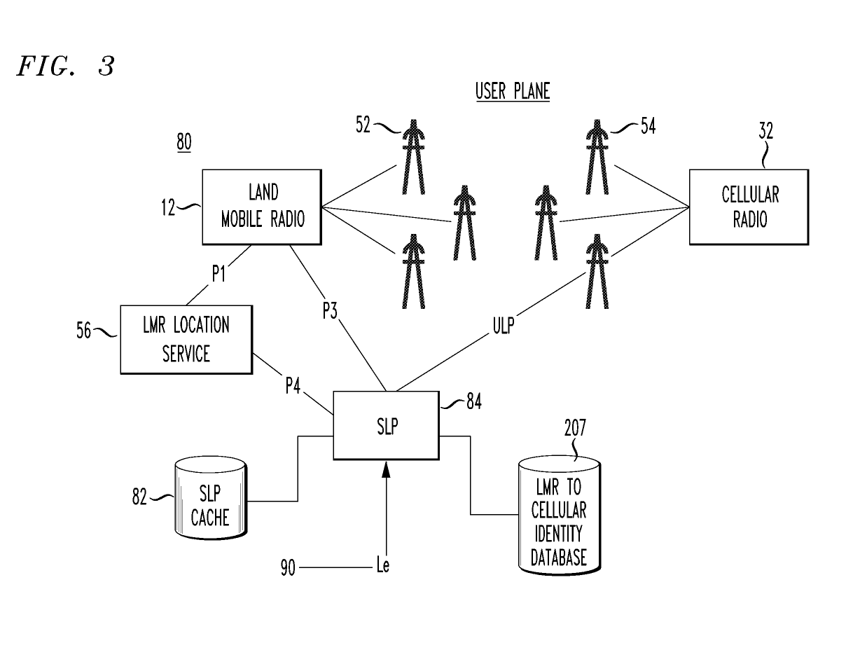

FIG. 3 shows an integrated land mobile radio (LMR) in a cellular location service using a user plane, in accordance with the principles of the present invention.

In particular, as shown in FIG. 3, a user plane location services embodiment includes a cellular radio 32 and an LMR 12 both being physically carried by a same user, and thus correlated in location.

The SLP components relevant to the user plane location services embodiment include an LMR Antenna/Repeater system 52, a Cellular LTE RAN 54, an LMR Location Service 56, a SUPL Location Platform (SLP) 84, an SLP Cache 82, and an Le Interface 90 that applications use to submit location requests.

### LMR Location Calculation Methods

The present invention adds network trilateration techniques otherwise unavailable in conventional land mobile radio position calculation methods, and enables location to be pushed into 3GPP GMLC in a control plane embodiment (FIG. 2), or into an SLP in a user plane embodiment (FIG. 3), such that LMR-determined location becomes available for use by location applications.

The present invention also adds network trilateration techniques otherwise unavailable in current land mobile radio (LMR) systems:

### LMR-Based Trilateration

The US is covered in repeaters that forward voice communications from a handheld device to other devices to facilitate communications. These repeaters may be analog repeaters or digital repeaters. Repeaters are deployed for commercial communications as well as for the Amateur Service.

All Amateur Service Radio repeaters broadcast their call sign at least every 10 minutes. It is assumed that commercial repeaters do similar.

The LMR system has a scanning mechanism that constantly looks for and processes the call sign or other identification data. As multiple repeaters are scanned, time delay techniques, SNR techniques and/or even angle of arrival techniques are utilized to determine the distance from multiple repeaters.

In the case of the user plane embodiment of FIG. 3, to be described hereinbelow, the OMA SUPL protocol allows a WiFi-capable LMR device to send in measurements for every WiFi Access Point that is visible to the WiFi-capable LMR device. If the given LMR device 12 supports WiFi, the access point list and RSSI measurements are sent from the LMR 12 to the SLP 84 via the ULP protocol. Thus, the SLP 84 can calculate a position based on its WiFi database.

### LMU Methods

In a GSM system such as shown in FIG. 2, a location measurement unit (LMU) makes radio measurements to support positioning of mobile devices 32. As described above, there is a series of repeaters. Similar to cellular LMU techniques, equipment at each repeater can determine the distance from an LMR 12 to the repeater. By combining the measurements from multiple repeaters, location of an individual LMR 12 can be determined.

For instance, the LMR 12 knows the current antenna/repeater it is transmitting to as well as the other antenna/repeaters that are “visible” to it. The GMLC includes a GMLC cache database 60 (FIG. 2), and the SLP includes an SLP cache database 82 (FIG. 3) to look up the antenna/repeaters and calculate location of a given LMR 12 based on the antenna/repeater(s) that are currently visible to the given LMR 12.

Observed time difference of arrival (OTDOA) measurements may also be utilized by the LMR 12 or the LMR network to determine its location.

### A-GPS

Current land mobile radios (LMRs) 12 support stand-alone global positioning satellite (GPS) methods. Satellite location determination can take up to 2 minutes to achieve. LMRs 12 may utilize their data packet interface to receive satellite assistance data to reduce the time to satellite acquisition,

### A-GNSS

Many LMRs 12 currently support Standalone GPS. The present invention enables satellite assistance data to be sent to the LMR 12 from an eSMLC 66 (in the control plane embodiment shown in FIG. 2) or from the SLP 84 (in the user plane embodiment shown in FIG. 3) to decrease the time to acquire satellite signals. The SLP 84 and eSMLC 66 provides satellite assistance data to the LMR 12 to acquire visible satellites and to aid in the location calculation. Location may be calculated on the LMR 12 or within the GMLC 58 (FIG. 2) or SLP 84 (FIG. 3).

Any location information that is transferred on the cellular location protocols or the new protocols are preferably shared across the components of the device. For example, satellite assistance data obtained via the SUPL protocol to the device is available to the device in the event that the cellular network fails.

Location Push from LMR into GMLC/SLP Cache

Once an LMR 12 obtains its location via either existing means or by methods described herein, the LMR location service 56 preferably pushes its location into the GMLC 58 via a P2 interface between the LMR 12 and the GMLC 58 (as shown in FIG. 2), or into the SLP 84 from the LMR 12 via the P3 interface (as shown in FIG. 3). The P2 and P3 interfaces preferably includes an LMR identification (ID), a timestamp, and location information (e.g., latitude, longitude, and uncertainty/accuracy). Preferably the P2 and P3 interfaces are the same interface.

The LMR 12 pushes calculated location using the techniques of this invention, and the currently supported S-GPS, into the GMLC location cache database 60. LMU type functionality at a repeater pushes calculated location into the GMLC cache database 60. For all location requests received at the GMLC 58, the GMLC cache database 60 is queried to see if the cached position from the LMR/Repeater meets the requested quality of position and can be used.

Location Pull from the GMLC/SLP to the Proprietary Location Server

Existing LMR infrastructure currently stores the location of each LMR 12 in a LMR Location Service server 56. The GMLC 58 (FIG. 2) or SLP 84 (FIG. 3) can query the LMR location service server 56 via interfaces P5 and P4, respectively. As disclosed herein, the interfaces P4 and P5 are preferably the same. The GMLC 58 sends in the identity of the LMR 12 device to be located (e.g., using its LMR ID), and in response the LMR location service 56 returns the LMR ID, timestamp and location (e.g., Iat, Ion, uncertainty) of the relevant LMR 12.

Positioning Protocol Mapping from Cellular to LMR

As can be seen in FIG. 1 and FIG. 2, a cellular device 32 and an LMR device 12 include similar basic components, including respective antennas 34, 14; WiFi modules 36, 16; location satellite chipset such as a GPS or a GLONASS module 38, 18; and transceivers 40, 20. The present invention enables LMR devices 12 with the same assistance data and position calculation methods as its cellular counterpart 32. Of course, the antenna and other systems are quite different, but have common that timing, power and other information can be determined between the LMR 12 and the antenna/repeater. In accordance with the present invention, location information data is passed within the positioning protocols of the respective LMR 12 or cellular device 32. For Control Plane positioning, this is the LPP and LPPa protocols; For User Plane positioning, this is ULP, LPP and LPPe protocols.

### Identity Mapping

The GMLC 58 in the control plane embodiment of FIG. 2, and the SLP 84 in the user plane embodiment of FIG. 3, communicate with an LMR to cell Identity Mapping Database 207 that maintains a plurality of entries mapping LMR identity (LMR ID) to an associated subscriber Cellular Identity (MDN, MSID, IMSI).

Preferably the entries maintained in the LMR to Cell Identity Mapping Database 207 are dynamic, and updated as necessary, as people generally pick up whatever LMR is charged out on any given day. The LMR to cell Identity Mapping Database 207 preferably comprises a simple lookup table that cross-references LMR ID, Cellular ID, and even Cellular ID Type. The GMLC 58 shown in FIG. 2, and the SLP 84 shown in FIG. 3, include a respective interface to the LMR to Cell Identity Mapping Database 207 which is utilized to store and retrieve the mapping data.

LMRs 12, and cellular devices 32, may have multiple identifiers. For the cellular device 32 it may be, e.g., an MSID (MDN, MSISDN). For LMRs 12, it may be, e.g., an LMR device ID, or may be a first responders call sign.

In accordance with the present invention, an LCS Client is able to request location by either an LMR or cell identity.

The GMLC 58 of the control plane embodiment of FIG. 2 is also preferably able to autonomously determine that a given person (e.g., a first responder) is carrying multiple devices such as a cell phone or other wireless device 32 and an LMR 12, based on a correlation of location information particularly over a given period of time as the devices move together. Once a wireless device 32 is associated with an LMR 12, i.e. that a given person is physically carrying multiple devices, then a location calculation for one device 12, 32 may be used for a location request for the identifier of another associated device 32, 12. The present invention provides the ability to locate a person who happens to be carrying two (or more) radio devices when one network (LMR or cell) is incapable of providing a current location of a mobile person for whatever reason (network outage, weather-related outage, emergency, etc.), while the other network (cell or LMR) is able to provide current location information.

A first responder, e.g., may be carrying their personal mobile device, a cellular network device 32, and a traditional LMR 12. In accordance with the present invention, the GMLC 58 includes the LMR to cell identity map database 207 to map and correlate these multiple devices.

The packet radio service for both existing LMRs and amateur devices support sending SMS and e-mail. These devices are preferably integrated into the relevant SMS-911 service.

Relevant location-based standards may utilized in accordance with the principles of the present invention. Exemplary standards include:

| SDO | Standard | Number | Purpose |
|---|---|---|---|
| 3GPP | 3GPP TS 23.271 | N/A | Location Services |
| | “Functional stage 2 | | Architecture |
| | description of Location | | including Control |
| | Services (LCS) | | Plane and User |
| | | | Plane |
| OMA | User Plane Location | ULP Interface | ULP is a data |
| | Protocol | between | connection |
| | | Cellular Radio | between cellular |
| | | (32) and SLP | device and SLP |
| | | (84) | |
| OMA | Mobile Location Protocol | Le (90) | Network Initiated |
| | | interface into | location request |
| | | GMLC (58) and | interface for |
| | | SLP (84) | applications to |
| | | | insert location |
| | | | requests |
| OMA | OMA-TS-LPPe-V2_0- | Positioning | Positioning layer |
| | 20140828 | layer between | within the ULP |
| | | SLP (84) and | protocol |
| | | cellular device | |
| | | (32) | |
| 3GPP | 3GPP TS 36.355 “Evolved | Protocol over | Control Plane |
| | Universal Terrestrial Radio | SLs interface | positioning |
| | Access (E-UTRA); LTE | between (64) | protocol. |
| | Positioning Protocol (LPP)” | and (66) | |
| 3GPP | 3GPP TS 36.455: “Evolved | Protocol over | Control Plane |
| | Universal Terrestrial Radio | S1-MME | positioning |
| | Access (E-UTRA); LTE | between (54) | protocol. |
| | Positioning Protocol Annex | and (64) | |
| | (LPPa)”. | | |
| 3GPP | 3GPP TS 29.173: | Protocol over | GMLC - MME |
| | “Diameter-based SLh | SLh interface | interface |
| | interface for Control Plane | between GMLC | |
| | LCS” | (58) and HSS | |
| | | (62) | |
| 3GPP | 3GPP TS 29.171: “LCS | Protocol over | E-SMLC - MME |
| | Application Protocol (LCS- | SLs interface | interface |
| | AP) between MME and E- | between | |
| | SMLC; SLs Interface” | eSMLC (66) | |
| | | and MME (64) | |
| 3GPP | 3GPP TS 36.413: “Evolved | Protocol over | MME to eNodeB |
| | Universal Terrestrial Radio | S1AP between | interface |
| | Access Network (E- | MME (64) and | |
| | UTRAN); S1 Application | Cellular RAN | |
| | Protocol (S1AP)” | (54) | |

3GPP Standards can be downloaded using: http://www.3qpp.org/dvnareporU23271.htm where 23271.htm is for standard 3GPP TS 23.271.

The present invention has particular applicability to enable commercial land mobile radio (LMR) providers GPS-based tracking of commercial devices. Also, to any company offering a combined LMR/cellular location service.

While the invention has been described with reference to the exemplary embodiments thereof, those skilled in the art will be able to make various modifications to the described embodiments of the invention without departing from the true spirit and scope of the invention.

What is claimed is:

1. A method of providing location of an LMR device in a cellular network, comprising:
storing, in a physical land mobile radio (LMR) wireless network location service, a current location of a given LMR device;
determining a correlation of location between said given LMR device and a given cellular device;
PULLing said current location of said given LMR device into a physical GMLC server; and
storing said current location of said given LMR device, and an identity of said given LMR device, and an identity of said given cellular device, into an LMR to cell identity mapping database;
wherein said current location of said given LMR device is accessible in a cellular wireless network to requests for location of said given cellular device.

2. The method of providing location of an LMR device in a cellular network according to claim 1, further comprising:
determining said current location of said given LMR device using LMR-based trilateration.

3. The method of providing location of an LMR device in a cellular network according to claim 1, further comprising:
determining said current location of said given LMR device using global positioning satellite (GPS) measurement of a location of said given LMR device.

4. The method of providing location of an LMR device in a cellular network according to claim 1, further comprising:
determining said current location of said given LMR device using assisted global positioning satellite (A-GPS) measurement of a location of said given LMR device.

5. The method of providing location of an LMR device in a cellular network according to claim 1, further comprising:
determining said current location of said given LMR device using global navigation satellite system (GNSS) measurement of a location of said given LMR device.

6. The method of providing location of an LMR device in a cellular network according to claim 1, further comprising:
determining said current location of said given LMR device using assisted-global navigation satellite system (A-GNSS) measurement of a location of said given LMR device.

7. A method of storing an LMR-determined location in a cellular location cache, comprising:
PUSHing, from a land mobile radio (LMR) location service server, a current location of a given LMR device into a physical GMLC server via an interface between said LMR service server and said GMLC server; and
PUSHing, from said physical GMLC server, said current location of said given LMR device into a GMLC location cache.

8. The method of storing an LMR-determined location in a cellular location cache according to claim 7, further comprising:
receiving a location request for a given cellular device correlated in location with said given LMR device; and
querying said GMLC location cache for said current location of said given LMR device;
providing said current location of said given LMR device, when satisfying a required quality of position, in response to said received location request for said given cellular device.

9. A method of storing an LMR-determined location in a cellular location cache, comprising:
PUSHing, from a land mobile radio (LMR) location service server, a current location of a given LMR device into a physical GMLC server via an interface between said LMR service server and said GMLC server; and
PUSHing, from said physical GMLC server, said current location of said given LMR device into a GMLC location cache.

10. The method of storing an LMR-determined location in a cellular location cache according to claim 9, further comprising:
receiving a location request for a given cellular device correlated in location with said given LMR device; and
querying said GMLC location cache for said current location of said given LMR device;
providing said current location of said given LMR device, when satisfying a required quality of position, in response to said received location request for said given cellular device.

11. A method of storing an LMR-determined location in a cellular location cache, comprising:
PUSHing, from a land mobile radio (LMR) location service server, a current location of a given LMR device into a physical SLP server via an interface between said LMR service server and said SLP server; and
PUSHing, from said physical SLP server, said current location of said given LMR device into an SLP location cache.

12. The method of storing an LMR-determined location in a cellular location cache according to claim 11, further comprising:
receiving a location request for a given cellular device correlated in location with said given LMR device;
querying said SLP location cache for said current location of said given LMR device; and
providing said current location of said given LMR device, when satisfying a required quality of position, in response to said received location request for said given cellular device.
